(19) United States
(12) Patent Application Publication
(10) Pub. No.: US 2021/0226853 A1
(43) Pub. Date: Jul. 22, 2021

(54) AUTOMATED NETWORK MONITORING AND CONTROL

(71) Applicant: ELISA OYJ, Helsinki (FI)

(72) Inventor: Henri KARIKALLIO, Helsinki (FI)

(73) Assignee: ELISA OYJ, Helsinki (FI)

(21) Appl. No.: 15/734,447

(22) PCT Filed: Jun. 26, 2019
(86) PCT No.: PCT/FI2019/050499

§ 371 Date: Dec. 2, 2020

(30) Foreign Application Priority Data
Jun. 29, 2018 (FI) 20185598

(51) Int. Cl. H04L 12/24

(52) U.S. Cl. CPC H04L 41/16; H04L 41/507; H04L 41/0609; H04L 41/5054; H04L 41/5067

(57) ABSTRACT

A computer implemented method of network monitoring and control. The method includes receiving alerts related to monitored devices; automatically analyzing the received alerts to determine a forthcoming predicted alert related to a monitored device; and automatically performing at least one predefined action for the monitored device based on the predicted alert.

### TECHNICAL FIELD

The present application generally relates to automated network monitoring and control.

### BACKGROUND

This section illustrates useful background information without admission of any technique described herein representative of the state of the art.

A network operation center (NOC) is generally a location from which NOC personnel exercises monitoring and control over a network. NOC personnel are responsible for monitoring one or many networks for certain conditions that may require special attention to avoid degraded service. NOC personnel follow screens showing events received from network devices, ongoing incidents and general network performance. NOC personnel decide upon required actions based on information they see on the screens.

Automation of NOC functionality of telecommunication networks has been developed in order to improve efficiency of network monitoring and control and to reduce the amount of manual work and human errors. But automation of network monitoring and control is not a straightforward task to implement.

### SUMMARY

Various aspects of examples of the disclosed embodiments are set out in the claims. Any devices and/or methods in the description and/or drawings which are not covered by the claims are examples useful for understanding the disclosed embodiments.

According to a first example aspect of the present disclosure, there is provided a computer implemented method of network monitoring and control. The method comprises

receiving alerts related to monitored devices;

a. automatically analyzing the received alerts to determine a forthcoming predicted alert related to a monitored device, wherein said automatic analyzing of the received alerts comprises determining time of said forthcoming predicted alert; and
b. automatically performing at least one predefined action for the monitored device based on the predicted alert.

In an embodiment, the predicted alert is such that it is considered to cause a need for reparative actions. In another embodiment, the predicted alert is such that it is considered to have customer impact.

In an embodiment, the automatic analyzing of the received alerts comprises identifying one or more alert patterns in the received alerts and determining said forthcoming predicted alert on the basis of the identified alert patterns.

In an embodiment, the automatic analyzing of the received alerts comprises determining type and time of said forthcoming predicted alert. In another embodiment, the automatic analyzing of the received alerts comprises determining type, category and time of said forthcoming predicted alert.

In an embodiment, the automatic analyzing of the received alerts is performed by an artificial intelligence module. The artificial intelligence module may be taught with a learning set comprising alert patterns leading to alerts that are considered to cause a need for reparative actions and/or considered to have customer impact.

In an embodiment, the method further comprises, prior to analyzing the alerts, filtering the received alerts to reduce the number of alerts to be analyzed.

In an embodiment, the method further comprises, prior to performing the at least one predefined action, confirming that automatic actions are applicable for the monitored device.

In an embodiment, the method further comprises, after a predefined period of time, checking whether the predicted alert has reappeared and responsively taking a further action.

In an embodiment, the received alerts indicate one or more of the following: faulty or degraded operation, degraded performance, unavailable service, and a change in external conditions.

In an embodiment, the predefined action is an action affecting operation of the monitored device.

In an embodiment, the predefined action comprises one or more of the following: resetting the monitored device, changing value of at least one parameter in the monitored device, closing a port in the monitored device, opening a port in the monitored device, automatically generating a ticket for manual action, and displaying or reporting the predicted alert.

In an embodiment, the monitored devices are network devices of a telecommunication network. The monitored device are for example base stations of a radio access network.

In an embodiment, the monitored devices are devices of a power grid or devices of a cable or television network.

In an embodiment, the monitored devices are electronic devices that are communicatively connected to a network monitoring and control system performing the method.

According to a second example aspect of the present disclosure, there is provided an apparatus comprising a processor and a memory including computer program code; the memory and the computer program code configured to, with the processor, cause the apparatus to perform the method of the first aspect or any related embodiment.

According to a third example aspect of the present disclosure, there is provided a computer program comprising computer executable program code which when executed by a processor causes an apparatus to perform the method of the first aspect or any related embodiment.

The computer program of the third aspect may be a computer program product stored on a non-transitory memory medium.

Different non-binding example aspects and embodiments of the present disclosure have been illustrated in the foregoing. The embodiments in the foregoing are used merely to explain selected aspects or steps that may be utilized in implementations of the present disclosure. Some embodiments may be presented only with reference to certain example aspects of the disclosure. It should be appreciated that corresponding embodiments may apply to other example aspects as well.

### BRIEF DESCRIPTION OF THE DRAWINGS

For a more complete understanding of example embodiments of the present disclosure, reference is now made to the following descriptions taken in connection with the accompanying drawings in which:

FIG. 1 shows an example scenario according to an embodiment;

FIG. 2 shows a system according to an embodiment;

FIG. 3 shows logical components of an example system suited for implementing certain embodiments;

FIGS. 4A-4E show flow diagrams illustrating example methods according to certain embodiments; and

FIG. 5 shows an apparatus according to an embodiment.

### DETAILED DESCRIPTION OF THE DRAWINGS

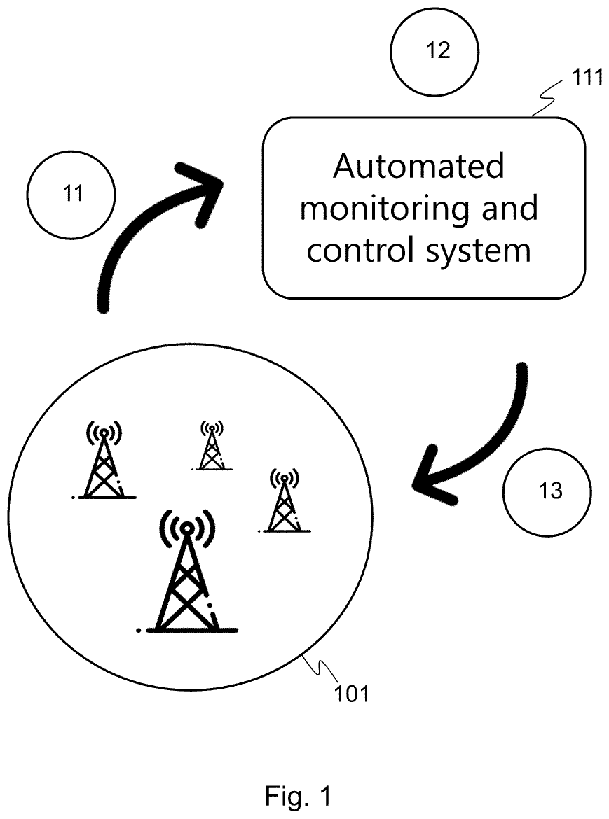

Example embodiments of the present disclosure and its potential advantages are understood by referring to FIGS. 1 through 5 of the drawings. In this document, like reference signs denote like parts or steps.

In an embodiment of the disclosed embodiments there is provided an automated network monitoring and control system. The developed automated solution can be employed in NOC functionality of a telecommunication network. Additionally or alternatively, the developed automated solution can be employed in monitoring and control of devices of a power grid or of devices of a cable or television network or some other group of monitored devices. In general, the developed automated solution can be employed for monitoring and control of any electronic devices that are communicatively connected to a network monitoring and control system implementing the automated solution. Various embodiments of the disclosed embodiments discussed in the following relate to monitoring of a telecommunication network, but it is to be understood that disclosed embodiments may be applied to other monitored devices, too. A monitored device in the sense of present disclosure can be any electronic device that is being monitored and/or controlled. It is to be noted that the group of monitored devices may be part of a larger system comprising also devices that are not being monitored. For example a telecommunication network may comprise a plurality of devices that are not being monitored or controlled through the present automated solution.

As operational load and network complexity increase due to increasing number of base stations and other network devices as well as increasing amount of manual work required for maintaining quality of network, there is increasing need for automation of network monitoring and control of telecommunication networks. At the same time the need for automated monitoring increases in other application areas, too.

FIG. 1 shows an example scenario according to an embodiment. The scenario shows a group of monitored devices 101 and an automated monitoring and control system 111. Alerts related to the monitored devices 101 are conveyed to the automated monitoring and control system 111 in phase 11. The cause for generation of an alert may be for example a fault in a monitored device such as one or more of the following: abnormal behaviour of a monitored device, hardware failure in a monitored device, exceeding a predefined threshold, synchronization problem, failure in operation of a functionality, excess load, insufficient storage capacity, insufficient processing resources, degraded performance etc. Performance of the monitored device or the whole system comprising the monitored device may be based on suitable performance indicators. The performance indicators may comprise for example counter values and/or Key Performance Indicator, KPI, values derived on the basis of one or more other performance indicators. In an example implementation, the performance indicators are observed over a predefined time and, if needed, an alert is generated on the basis of the observations. Additionally or alternatively, in a telecommunication network the cause for generation of an alert may be for example one or more of the following: abnormal behaviour of a base station, transmission problem in a network link, existence of an SNMP (Simple Network Management Protocol) trap, degraded throughput etc. Additionally or alternatively, the source of the alert may be an external system, such as a weather database or a traffic data source or a call data record (CDR) database.

The automated monitoring and control system 111 analyses the alerts in 12 to automatically decide on actions to be taken. The automatically decided actions are performed on one or more monitored devices in phase 13. It is to be noted that the action is decided and performed autonomously without human interaction. Furthermore, it is to be noted that the device originating the alert may be different from the device in which the automated action is applied. Additionally or alternatively, the automatically decided action may be generation of a ticket for manual action. In this case human actions may be used for solving the issue. The shown process is continuously repeated. Additionally, if the fault causing the alert(s) is not fixed by the automatic action and/or the alert reappears, a ticket for manual action may be generated.

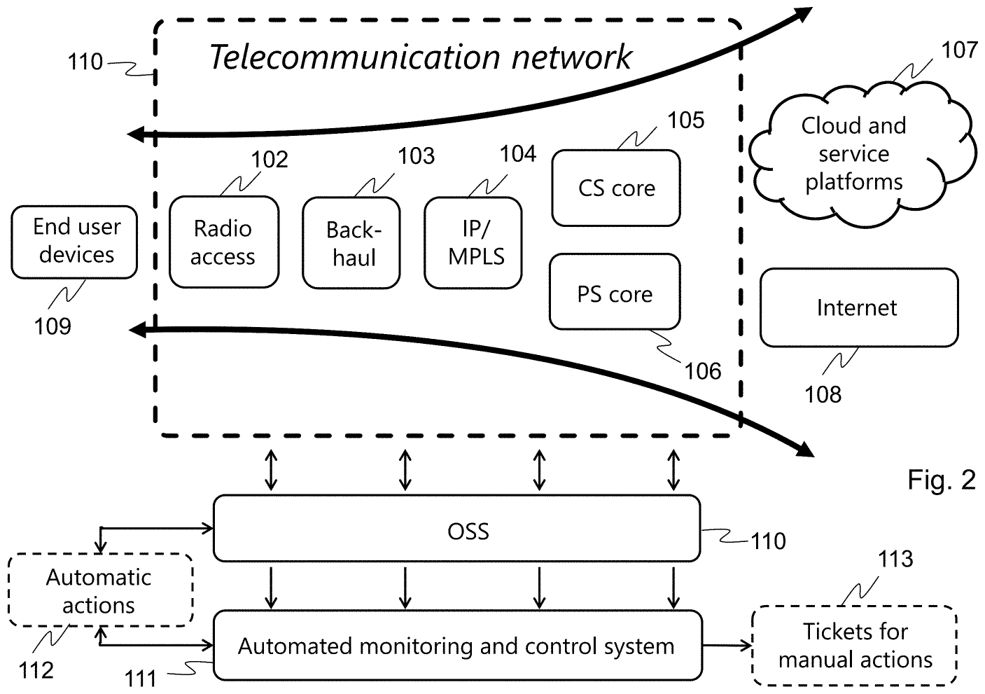

FIG. 2 shows a system according to an embodiment. The system comprises a telecommunication network 110, user devices 109, cloud and service platforms 107 and Internet 108. The telecommunication network 110 serves user devices 109 connected to the telecommunication network 110. The telecommunication network 110 provides communication services to the user devices such as for example access to cloud and service platforms 107 and Internet 108 and other systems. The telecommunication network 110 may be divided into a radio access network 102 comprising base stations that provide radio interface for connecting to the telecommunication network 110, a backhaul portion 103 that connects the radio interface of the radio access network 110 to other parts of the network, IP/MPLS (Internet Protocol/Multiprotocol Label Switching) portion 104 that provides data-carrying services for both circuit switched and packet switched communications, a circuit switched core network 105 for circuit switched communications and a packet switched core network 106 for packet switched communications.

Further the system of FIG. 2 comprises an OSS (Operations Support System) 110 and an automated monitoring and control system 111. The OSS continuously collects alerts from one or more monitored devices of the telecommunication network 110. For example hardware failure in a base station of the radio access network 102 causes generation of an alert that is then conveyed to the OSS. The alerts received in the OSS are conveyed to the automated monitoring and control system 111. The automated monitoring and control system 111 analyses the alerts to automatically decide on actions that may be required. The action may be an automatic action 112 performed on one or more monitored devices of the telecommunication network, such as resetting a monitored device, changing value of at least one parameter in a monitored device, closing a port in a monitored device, or opening a port in a monitored device. Alternatively or additionally the action may be generation of an alert ticket for manual action.

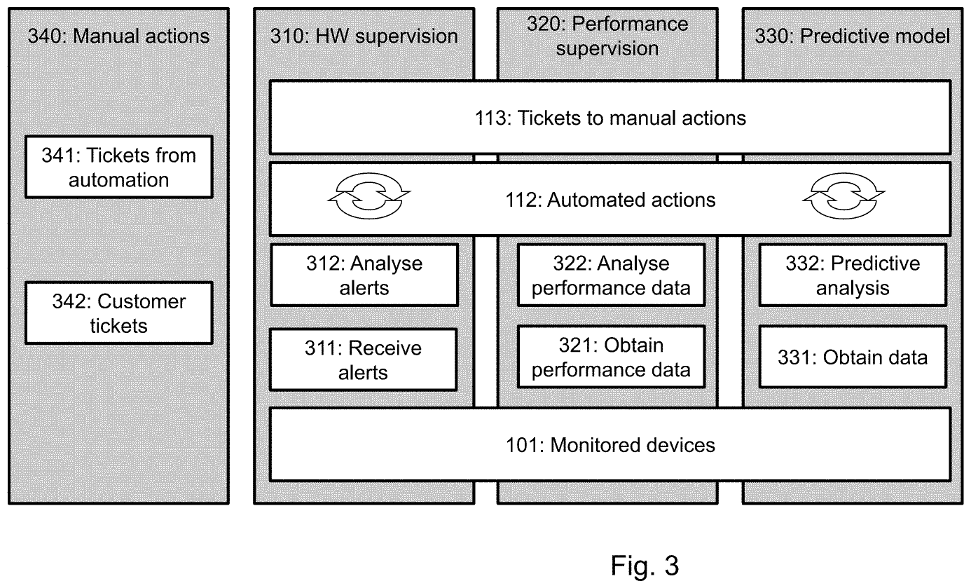

FIG. 3 shows logical components of an example system suited for implementing certain embodiments. The system is divided into a hardware supervision block 310, a performance supervision block 320, a predictive supervision block 330 and a manual actions block 340. The hardware supervision block 310 concerns collecting and analyzing 311, 312 alerts received from physical monitored devices, and automatically deciding and performing actions based on the analysis 112 and possibly generating tickets for manual actions 113. The performance supervision block 320 concerns collecting and analyzing performance data related to monitored devices 321, 322, and automatically deciding and performing actions based on the analysis 112 and possibly generating tickets for manual actions 113. The predictive supervision block 330 concerns collecting 331 data from the monitored devices, the data comprising for example alerts and/or performance data, and predicting forthcoming alerts or incidents based on collected data 332. The predicted alerts or incidents are then used for deciding and performing actions 112 and possibly for generating tickets for manual actions 113. The manual actions block 340 concerns manually performed work, such as 342: handling of tickets relating to customer complaints and 341: handling of tickets generated by the automatic process of one of the blocks 310-330. It is to be noted that data for the hardware supervision, performance supervision and predictive supervision blocks 310, 320, 330 may be collected from other external sources, too. For example weather or traffic data may be collected. Certain embodiments of present disclosure relate mainly but not exclusively to the predictive supervision block 330.

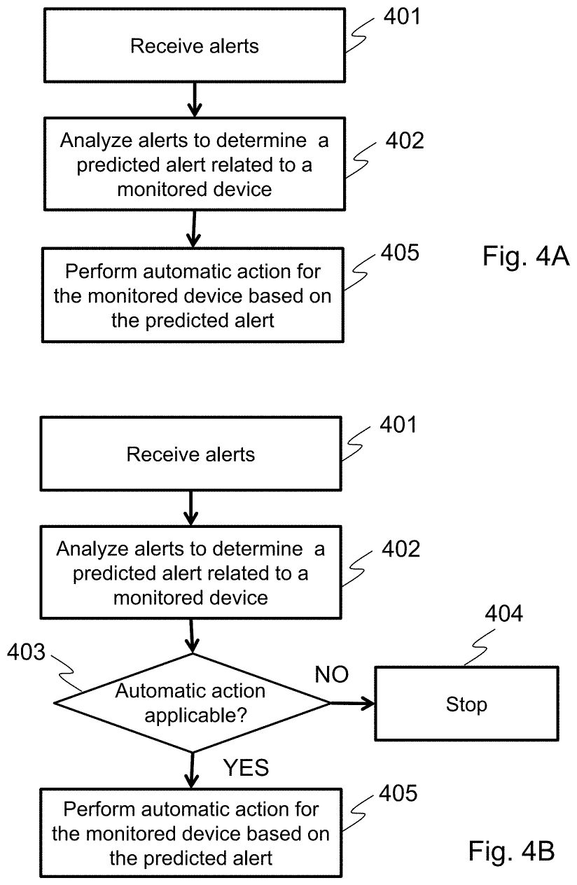

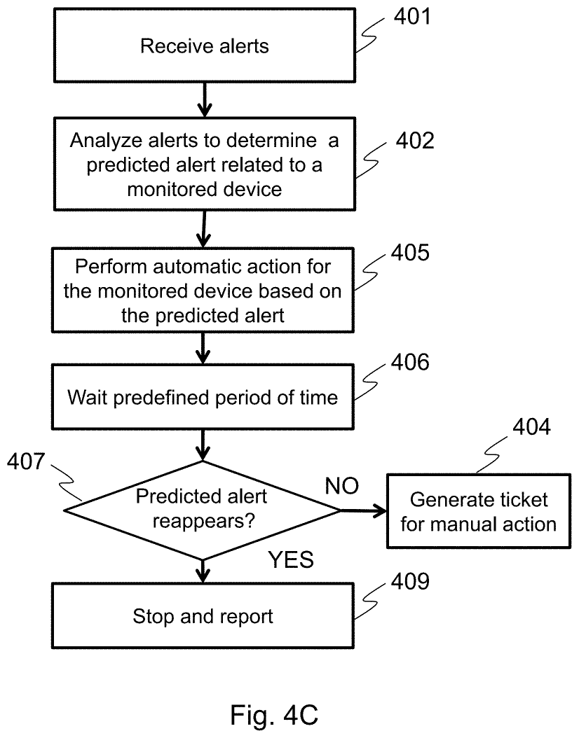

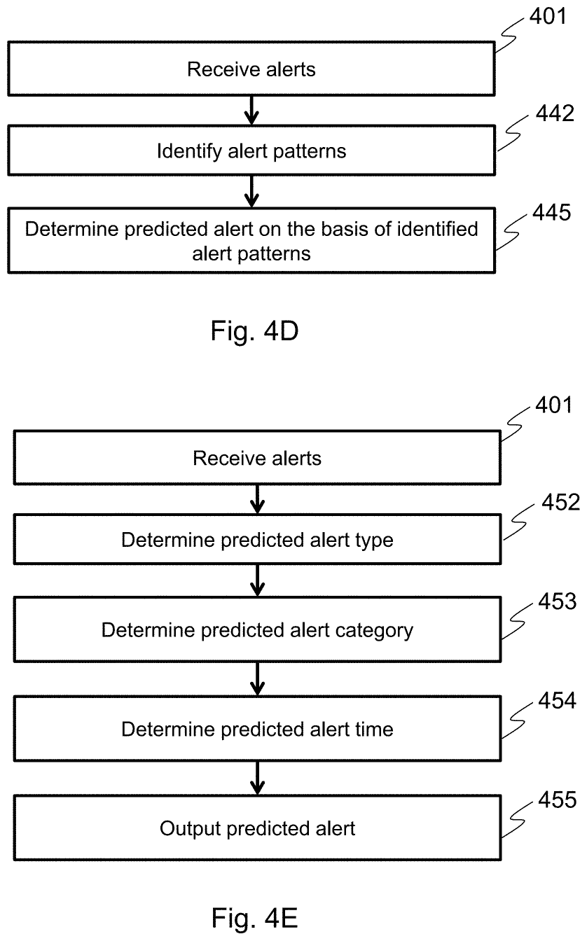

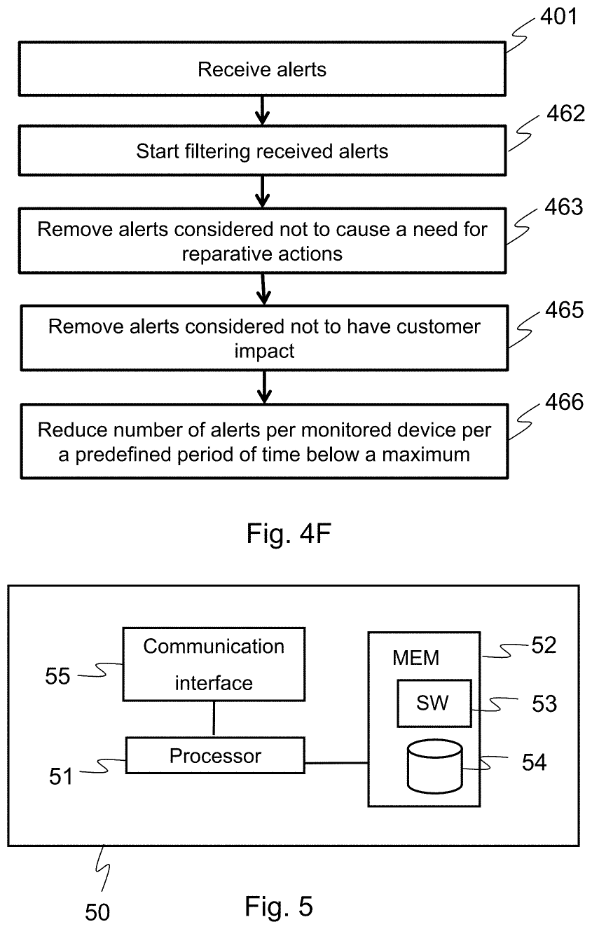

FIGS. 4A-4F show flow diagrams illustrating example methods according to certain embodiments. The methods may be implemented in the automated monitoring and control system 111 of FIGS. 1 and 2. The methods are implemented in a computer and do not require human interaction. It is to be noted that the methods may however provide output that may be further processed by humans. The methods of FIGS. 4A-4F may be combined with each other and the order of phases conducted in each method may be changed expect where otherwise explicitly defined. Furthermore it is to be noted that performing all phases of the flow charts is not mandatory.

FIG. 4A shows a flow diagram illustrating a method according to an embodiment of the disclosed embodiments. The method comprises following phases:

Phase 401: Alerts are received. The alerts may be alerts concerning faults in operation of monitored devices. The faults may concern hardware problems, unavailable services or degraded performance as discussed in connection with FIG. 1. Additionally or alternatively the source of alerts may be an external source, such as weather database or traffic surveillance database.

Phase 402: The received alerts are analyzed and a forthcoming predicted alert related to a monitored device is determined. The prediction concerning the forthcoming alert is made based on the received alerts. Suitable artificial intelligence tools may be used for performing this. Alternatively, predefined rules or decision logic may be used for performing this. In an embodiment, the predicted alert is such that that it is considered to cause a need for reparative actions. Additionally or alternatively, the predicted alert may be such that it is considered to have customer impact. In an embodiment, an artificial intelligence module that performs analysis of the received alerts is being taught with a learning set comprising alert patterns leading to alerts that are considered to cause a need for reparative actions and/or to alerts considered to have customer impact. Further details of determining the predicted alert are discussed for example in connection with FIGS. 4D and 4E.

Additionally, the analysis phase 402 may comprise filtering the received alerts to reduce the number of alerts in further processing and/or classifying the received alerts to different categories.

In an embodiment the predictions of phase 402 are performed periodically for example every 10, 15, 20 or 30 minutes or every 1 or 2 hours.

Phase 405: An action is performed for the monitored device based on the predicted alert. The action may be chosen for example based on predefined rules or predefined logic charts. It is to be noted that more than one predicted alerts related to the monitored device may have been determined and the action may be chosen on the basis of more than one predicted alerts. That is, there may be a certain set of predicted alerts that leads to a certain action, while one single predicted alert may lead to another action. It is to be noted that in this context an action may comprise a single action or more than one actions. It is to be noted that performing the prediction in phase 402 and deciding upon and performing the action in phase 405 are two independent processes and that the action performed in phase 405 may be simply reporting or displaying the predicted alert or generation of a ticket for manual operations. In an embodiment the action is however an action that has direct effect on operation of the monitored device, such as e.g. resetting the device or changing parameters in the device. Further it is to be noted that the process performing the phase 405 may obtain alerts also from other sources in addition to the predicted alerts.

In an embodiment the process in phase 402 provides to phase 405 additional information about the circumstances preceding the predicted alert. In this way the process in phase 405 may take different action depending on the circumstances causing the predicted alert.

By performing the action on the basis of a predicted alert, i.e. based on an alert that has not occurred yet, operation failures may be completely avoided. This may have considerable positive impact on customer satisfaction. Problems in monitored devices may be fixed earlier than in previous solutions. In an example case, a cell faulty alert occurred at 14.26 hours while the predictive solution of an embodiment indicated that such alert would occur already at 13.38 hours. In another example case, a cell faulty alert occurred at 13.58 hours while the predictive solution of an embodiment indicated that such alert would occur already at 06.53 hours.

FIG. 4B shows a flow diagram illustrating a method according to an embodiment of the present disclosure. The method comprises following phases:

Phases 401 and 402: Alerts are received and analyzed to determine predicted alert similarly to FIG. 4A.

Phase 403: It is checked whether an automatic action can be applied to the monitored device. In general this refers to checking whether performing an automatic action would interfere with some other ongoing action or whether there is some other matter that indicates the automatic action should be avoided.

If it is concluded that automatic actions are not applicable, processing of the predicted alert is terminated in phase 404. A report of the predicted alert may be generated, though. Additionally or alternatively, a ticket for manual operations may be generated so that human intervention is possible if needed. If it is concluded that automatic actions are applicable, the process proceeds to phase 405. In phase 405, an action is performed for the monitored device based on the predicted alert similarly to FIG. 4A. By checking applicability of automatic actions, one achieves that risk of automatically performing unnecessary or even harmful actions can be reduced. This is beneficial in connection with any alert, but especially predicted alerts related to degraded performance might cause unnecessary actions to be taken if such checking phase was not performed.

For example one or more of the following situations may lead to concluding that automatic actions are not applicable: a ticket associated with the monitored device already exists, the monitored device is in a quarantine list, a rollout process is being performed in the monitored device, the monitored device is in maintenance, and a specified threshold has been exceeded. In this way one achieves that automatic actions do not interfere with any ongoing actions being performed in the monitored device. By using the quarantine list and/or the thresholds one achieves that automatic action is not repeatedly performed, if it appears that the automatic action does not repair any problems.

FIG. 4C shows a flow diagram illustrating a method according to an embodiment of the present disclosure. The method comprises following phases:

Phases 401, 402 and 405: Alerts are received and analyzed to determine predicted alert and to perform automatic action similarly to FIG. 4A.

Phase 406: After performing the action, the process waits for a predefined period of time. This may be for example 5 min, 10 min, 20 min, 30 min, 1 h or 3 h.

Phase 407: It is checked whether the predicted alert reappears. If the predicted alert has not reappeared, the process stops in phase 409 and a report is generated to log the predicted alert and the action that was taken by the automatic process. If the predicted alert reappears, a ticket for manual action is generated in phase 404. Alternatively or additionally, the process may return to phase 405 to repeat the action for the monitored device. Yet another alternative (not shown in FIG. 4A) is to perform for the monitored device another action different from the action performed in phase 405.

By checking whether the predicted alert reappears and generating a ticket for manual action if necessary, one achieves that the automatic system does not continue to perform the automatic action forever, if the action is not fixing the problem.

In an embodiment the alert that is predicted in phase 402 is a cell faulty alert in a telecommunication network and the action that is performed in phase 405 is resetting the monitored device (the monitored device may be for example a base station). For example existence of one or more of the following alerts may be considered a cell faulty alert: monitored device disconnected, base station down, cell out of service, cell unavailable, and transmission interruption.

Other embodiments comprise the following different embodiments:

The alert that is predicted in phase 402 is an indication of no data transmission in a cell and the action that is performed in phase 405 is reactivating data transmission in the cell by resetting the monitored device.

The alert that is predicted in phase 402 is an indication of no data transmission in a cell and the action that is performed in phase 405 is reactivating data transmission in the cell by deactivating and activating a GPRS (General Packet Radio Service) parameter.

The alert that is predicted in phase 402 is an indication of a fault in VSWR (Voltage Standing Wave Ratio) antenna monitoring or a VSWR alarm and the action that is performed in phase 405 is generation of a ticket for manual action.

The alert that is predicted in phase 402 is an indication of a power unit output voltage fault and the action that is performed in phase 405 is generation of a ticket for manual action.

The alert that is predicted in phase 402 is an indication of a fault in the chain between a power unit and MHA (MastHead Amplifier) and the action that is performed in phase 405 is generation of a ticket for manual action.

The alert that is predicted in phase 402 is an indication of a LAN (Local Area Network) error or a communication error and the action that is performed in phase 405 is resetting the monitored device.

The alert that is predicted in phase 402 is an indication of a control plane problem and the action that is performed in phase 405 is deactivating and activating LTE (Long Term Evolution) S1 link.

The alert that is predicted in phase 400 is an indication of exceeded threshold in Twamp (Two-Way Active Measurement Protocol) measurement and the action that is performed in phase 405 is resetting the network device.

The alert that is identified in phase 400 is an indication of over 20 Bad Uplink events in a day or an indication of over 20 abnormal distribution events and the action that is performed in phase 405 is locking and opening a cell. It is to be noted that instead of 20, the threshold may be some other number such as for example 10, 30 or 50.

FIG. 4D shows a flow diagram illustrating a method according to an embodiment of the disclosed embodiments. The method concerns an example implementation of the analysis phase 402 of FIG. 4A and the method may be performed for example by artificial intelligence tools. The method comprises following phases:

Phase 401: Alerts are received similarly to FIG. 4A.

Phase 442: Alert patterns are identified.

Phase 445: Forthcoming predicted alert is determined on the basis of the identified alert patterns. That is, it is predicted how the identified alert pattern is likely to continue.

FIG. 4E shows a flow diagram illustrating a method according to an embodiment of the present disclosure. The method concerns an example implementation of the analysis phase 402 of FIG. 4A and the method may be performed for example by artificial intelligence tools. The method comprises following phases:

Phase 401: Alerts are received similarly to FIG. 4A.

Phase 452: It is determined what type of predicted alert is likely to occur.

Phase 453: Category of the predicted alert is determined. The category may indicate severity of the alert. In an example implementation there are four categories: notification, minor, major and critical. Different alert category may lead to different automatic action. For example alerts in notification category may not require any actions whereas alerts in critical category typically cause customer impact and require actions.

Phase 454: It is determined when the predicted alert is likely to occur. By predicting forthcoming alerts and their timing (the moment of time when the alert is likely to occur) it is for example possible to improve timing of corrective actions. For example, if it is determined that certain alert is likely to appear in one week's time or after two weeks, the associated corrective action can be delayed, too. In this way actions affecting operation of the monitored devices are not performed too early before they are needed.

Phase 455: The predicted alert is output for further actions. It is to be noted that in an example implementation phases 452 and 453 of FIG. 4A are not mandatory although it may be beneficial to predict also at least one of the type and the category of the forthcoming alert to be able to better select the most suitable action to prevent the alert.

FIG. 4F shows a flow diagram illustrating a method according to an embodiment of the present disclosure. The method concerns filtering the alerts prior to further processing. This may be part of phase 402 of FIGS. 4A-4C for example. The filtering may be performed on the basis of predefined rules. The method comprises following phases:

Phase 401: Alerts are received.

Phase 462: Filtering of the received alerts is started to reduce the number of alerts in further processing.

Phase 463: Alerts considered not to cause a need for reparative actions are removed. There may be for example some alerts that are known to cause for example degraded performance, but that cannot be fixed or that are known to automatically disappear.

Phase 465: Alerts considered not to have customer impact are removed. There may be for example some alerts that a known not to affect customer experience or some alerts that cannot be avoided but do not require any actions to be taken in view of customer experience. Such filtering may reduce the number of alerts considerably. For example in an example scenario concerning a telecommunication network only 50 000 alerts out of 1 000 000 alerts may be considered to have customer impact.

Phase 466: Alerts per monitored device per a predefined time period are reduced below a maximum number. The maximum number may be for example 3, 4, 5, 6, 7 or 10 and the time period may be for example 10 min, 30 min, 1 h or 3 h.

FIG. 5 shows an apparatus 50 according to an embodiment. The apparatus 50 is for example a general-purpose computer or server or some other electronic data processing apparatus. The apparatus 50 can be used for implementing embodiments of the present disclosure. That is, with suitable configuration the apparatus 50 is suited for operating for example as the network monitoring and control system 111 of foregoing disclosure.

The general structure of the apparatus 50 comprises a processor 51, and a memory 52 coupled to the processor 51. The apparatus 50 further comprises software 53 and database 54 stored in the memory 52 and operable to be loaded into and executed in the processor 51. The software 53 may comprise one or more software modules and can be in the form of a computer program product. The database 54 may be usable for storing e.g. rules and patterns for use in data analysis. Further, the apparatus 50 comprises a communication interface 55 coupled to the processor 51.

The processor 51 may comprise, e.g., a central processing unit (CPU), a microprocessor, a digital signal processor (DSP), a graphics processing unit, or the like. FIG. 5 shows one processor 51, but the apparatus 50 may comprise a plurality of processors.

The memory 52 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The apparatus 50 may comprise a plurality of memories. The memory 52 may be constructed as a part of the apparatus 50 or it may be inserted into a slot, port, or the like of the apparatus 50 by a user.

The communication interface 55 may comprise communication modules that implement data transmission to and from the apparatus 50. The communication modules may comprise, e.g., a wireless or a wired interface module. The wireless interface may comprise such as a WLAN, Bluetooth, infrared (IR), radio frequency identification (RF ID), GSM/GPRS, CDMA, WCDMA, or LTE (Long Term Evolution) radio module. The wired interface may comprise such as Ethernet or universal serial bus (USB), for example. Further the apparatus 50 may comprise a user interface (not shown) for providing interaction with a user of the apparatus. The user interface may comprise a display and a keyboard, for example. The user interaction may be implemented through the communication interface 55, too.

The database 54 may be certain memory area in the memory 52 or alternatively the database 54 may be a separate component or the database 54 may be located in a physically separate database server that is accessed for example through the communication unit 55. The database unit 54 may be a relational (SQL) or a non-relational (NoSQL) database.

A skilled person appreciates that in addition to the elements shown in FIG. 5, the apparatus 50 may comprise other elements, such as microphones, displays, as well as additional circuitry such as memory chips, application-specific integrated circuits (ASIC), other processing circuitry for specific purposes and the like. Further, it is noted that only one apparatus is shown in FIG. 5, but the embodiments of the present disclosure may equally be implemented in a cluster of shown apparatuses.

Without in any way limiting the scope, interpretation, or application of the claims appearing below, a technical effect of one or more of the example embodiments disclosed herein is ability to automate network monitoring and control in telecommunication networks.

Another technical effect of one or more of the example embodiments disclosed herein is that increasing number of issues in monitored devices can be solved before they are visible to end users thereby improving user experience. Another technical effect of one or more of the example embodiments disclosed herein is that complex systems with increasing traffic amount can be handled without necessarily needing additional personnel for network monitoring tasks.

Another technical effect of one or more of the example embodiments disclosed herein is that risk of human errors may be reduced. For example in a NOC functionality it is likely that due to huge amount of alerts to be monitored, some alerts may go unnoticed by the monitoring personnel. Whereas, in the automated solution, all alerts are equally processed.

If desired, the different functions discussed herein may be performed in a different order and/or concurrently with each other. Furthermore, if desired, one or more of the before-described functions may be optional or may be combined.

Although various aspects of the disclosed embodiments are set out in the independent claims, other aspects of the disclosed embodiments comprise other combinations of features from the described embodiments and/or the dependent claims with the features of the independent claims, and not solely the combinations explicitly set out in the claims.

It is also noted herein that while the foregoing describes example embodiments of the present disclosure, these descriptions should not be viewed in a limiting sense. Rather, there are several variations and modifications, which may be made without departing from the scope of the present disclosure as defined in the appended claims.

1. A computer implemented method of network monitoring and control, the method comprising
receiving alerts related to monitored devices;
automatically analyzing the received alerts to determine a forthcoming predicted alert related to a monitored device, wherein said automatic analyzing of the received alerts comprises determining time of said forthcoming predicted alert; and
automatically performing at least one predefined action for the monitored device based on the predicted alert.

2. The method of claim 1, wherein the predicted alert is such that it is considered to cause a need for reparative actions and/or to have customer impact.

3. The method of claim 1, wherein said automatic analyzing of the received alerts comprises
identifying one or more alert patterns in the received alerts and determining said forthcoming predicted alert on the basis of the identified alert patterns.

4. The method of claim 1, wherein said automatic analyzing of the received alerts comprises
determining type and time of said forthcoming predicted alert.

5. The method of claim 1, wherein said automatic analyzing of the received alerts is performed by an artificial intelligence module.

6. The method of claim 5, wherein said artificial intelligence module has been taught with a learning set comprising alert patterns leading to alerts that are considered to cause a need for reparative actions and/or considered to have customer impact.

7. The method of claim 1, further comprising
prior to analyzing the alerts, filtering the received alerts to reduce the number of alerts to be analyzed.

8. The method of claim 1, further comprising
prior to performing the at least one predefined action, confirming that automatic actions are applicable for the monitored device.

9. The method of claim 1, further comprising
after a predefined period of time, checking whether the predicted alert has reappeared and responsively taking a further action.

10. The method of claim 1, wherein the received alerts indicate one or more of the following: faulty or degraded operation, degraded performance, unavailable service, and a change in external conditions.

11. The method of claim 1, wherein the predefined action is an action affecting operation of the monitored device.

12. The method of claim 1, wherein the predefined action comprises one or more of the following: resetting the monitored device, changing value of at least one parameter in the monitored device, closing a port in the monitored device, opening a port in the monitored device, and automatically generating a ticket for manual action.

13. The method of claim 1, wherein the monitored devices are network devices of a telecommunication network.

14. The method of claim 1, wherein the monitored devices are devices of a power grid or devices of a cable or television network.

15. The method of claim 1, wherein the monitored devices are electronic devices that are communicatively connected to a network monitoring and control system performing the method.

16. An apparatus comprising
a processor, and
a memory including computer program code; the memory and the computer program code configured to, with the processor, cause the apparatus to perform the method of claim 1.

17. A computer program comprising computer executable program code which when executed by a processor causes an apparatus to perform the method of claim 1.
